(19) United States
(12) Patent Application Publication
(10) Pub. No.: US 2010/0145783 A1
(43) Pub. Date: Jun. 10, 2010

(54) CAMPAIGN INFORMATION PROCESSING SYSTEM FOR PREMIUM CAMPAIGN

(75) Inventors: Yuzo Ono, Tokyo (JP); Ryuya Tanabe, Tokyo (JP); Hisashi Nakamichi, Tokyo (JP)

Correspondence Address: PEARNE & GORDON LLP, 1801 EAST 9TH STREET, SUITE 1200, CLEVELAND, OH, 44114-3108, US

(73) Assignee: DENTSU, INC., Tokyo (JP)

(21) Appl. No.: 12/067,567

(22) PCT Filed: Sep. 19, 2006
(86) PCT No.: PCT/JP2006/318506

§ 371 Date: Dec. 30, 2008

(30) Foreign Application Priority Data
Sep. 26, 2005 (JP) 2005-278732

(51) Int. Cl. G06Q 30/00; G06Q 10/00; G06F 17/30

(52) U.S. Cl. 705/14.25; 705/30; 707/758; 707/E17.014

(57) ABSTRACT

A campaign information processing system enabling reduction of the work of application to a campaign and enhancement of the campaign effect by changing the condition of application qualification according to the purchaser and the purchase environment. A purchase history data storage section (33) stores purchase history data including electronic settlement ID data and purchased product codes. The electronic settlement ID is, for example, an electronic money number. A campaign object product code storage section (35) stores campaign object product codes. A campaign application qualification recording section (41) creates and records campaign application qualification data in respect of the electronic settlement ID data included in the purchase history data including the purchase product code matching the campaign object product code. Points are calculated according to a point rule, and application qualification is given when the points reach a predetermined value. The point rule is so determined that the given point(s) vary with the gender or age of the purchaser or the date or place of purchase of the purchase environment.

### TECHNICAL FIELD

The present invention relates to a campaign information processing system which performs data processing for generating an application qualification for a premium campaign on a computer, and more particularly, to an information processing system which can improve convenience of customers and further increase an effect of the campaign.

### BACKGROUND ART

Conventionally, premium campaigns have been actively implemented for promoting sales of commodities (goods or merchandises). The premium campaign is an approach for the sales promotion for the purpose of recognition of the commodity or increase in the sales, and promotes the sales by providing premiums (privileges) such as giveaways and gifts. The premium campaign can motivate consumers by setting attractive giveaways and the like to enhance motivation for purchasing the commodity, or impress the consumers with characteristics of the commodity or a brand image. The premium campaign is divided into an open type which is not contingent on the purchase of the commodity and a closed type which is contingent on the purchase of the commodity. The present invention mainly relates to the premium campaign of the closed type.

In a conventional and general premium campaign, an application sticker is put on the commodity. This application sticker is put on a postcard and the postcard is posted. Thereby, a customer who purchases the commodity can apply for the campaign.

In the above described premium campaign, it is troublesome to prepare the postcard and post it. Consequently, in order to enable the customer to more easily apply for the premium campaign, a campaign information processing system using the Internet has been put into practical use. In this kind of information processing system, an application code number attached to the commodity is inputted to a mobile phone or the like and transmitted via the Internet. Thereby, the customer who has purchased the commodity can apply for the campaign. This kind of system is disclosed, for example, in Japanese Patent No. 3356422 (3 to 6 pages, all figures and the like).

Japanese Patent Laid-Open No. 2002-63460 (3 to 4 pages, FIG. 1 and the like) proposes a system for realizing a manufacturer(maker)-specific campaign by using a point card and a POS (Point Of Sales) system of a retail store. In this system, a purchaser and a purchased commodity are identified from the point card and POS data, and the premium is granted to the purchaser of a campaign target commodity.

However, in the conventional information processing system for the campaign, since the purchaser has to input the application code number and transmit the application code number via the Internet each time the purchaser purchases the commodity, an application task is troublesome for the purchaser. In the system using the point card, although the trouble of the application task can be saved, it is necessary to create the point card of the retail store as a presupposition of the application for the campaign, which therefore has been still troublesome. Moreover, a customer who hesitates to create the point card has not been able to easily participate in the campaign.

Further, the present inventor has studied the conventional information processing system for the campaign. As a result, in the conventional system, the purchase of the target commodity is simply a condition of generating an application qualification. Basically, other conditions do not affected the application qualification. In contrast to this, the present inventor considers that “if the condition of generating the application qualification can be changed depending on a purchaser condition (purchase-oriented condition) like what kind of person performs the purchase, or if the condition of generating the application qualification can be changed depending on a purchase environmental condition like what time or place the purchase is performed at, it is possible to promote the sales with respect to strategic target customers or promote the sales in strategically specific environments to improve an effect of the campaign”. However, a campaign in consideration of such purchase conditions has not been realized in the campaign of a postcard form, and also has not been realized in the conventional information processing system for the campaign.

### DISCLOSURE OF THE INVENTION

### Problems that the Invention is to Solve

The present invention has been made under the above described background, and it is an object of the present invention to provide an information processing system for a campaign which can reduce the troublesome work of the campaign application task and is convenient for the customer.

Further, it is an object of the present invention to provide an information processing system in which the condition of generating the application qualification is changed depending on the purchase condition such as the purchaser (purchase-oriented) or purchase environmental condition, and the effect of the campaign can be increased.

### Means for Solving the Problems

A campaign information processing system of the present invention is a system which performs data processing for generating an application qualification for a premium campaign on a computer. This system is provided with a purchase history data storage unit which stores purchase history data including electronic payment ID data specific to each electronic payment medium and a purchased commodity code which is a commodity code of a purchased commodity, as data on history of purchasing the commodity by using the electronic payment medium; a campaign target commodity code storage unit which stores a campaign target commodity code which is the commodity code of a campaign target commodity of a target campaign; and a campaign application qualification generation and registration unit which compares the purchased commodity code included in the purchase history data in the purchase history data storage unit, with the campaign target commodity code in the campaign target commodity code storage unit, generates a campaign application qualification corresponding to the electronic payment ID data included in the purchase history data including the purchased commodity code which matches the campaign target commodity code, and registers the campaign application qualification data in association with the electronic payment ID data.

Another aspect of the present invention is a campaign information processing method which performs data processing for generating an application qualification for a premium campaign on a computer, in which a purchase history data storage unit configured with storage means of the computer stores purchase history data including electronic payment ID data specific to each electronic payment medium and a purchased commodity code which is a commodity code of a purchased commodity, as data on history of purchasing the commodity by using the electronic payment medium; a campaign target commodity code storage unit configured with the storage means of the computer stores a campaign target commodity code which is the commodity code of a campaign target commodity of a target campaign; and the campaign information processing method compares the purchased commodity code included in the purchase history data in the purchase history data storage unit, with the campaign target commodity code in the campaign target commodity code storage unit, generates a campaign application qualification corresponding to the electronic payment ID data included in the purchase history data including the purchased commodity code which matches the campaign target commodity code, and registers the campaign application qualification data in association with the electronic payment ID data.

Another aspect of the present invention is a campaign information processing program which causes a computer to execute data processing for generating an application qualification for a premium campaign, and causes the computer to execute a process of causing a purchase history data storage unit configured with storage means of the computer to store purchase history data including electronic payment ID data specific to each electronic payment medium and a purchased commodity code which is a commodity code of a purchased commodity, as data on history of purchasing the commodity by using the electronic payment medium; causing a campaign target commodity code storage unit configured with the storage means of the computer to store a campaign target commodity code which is the commodity code of a campaign target commodity of a target campaign; and comparing the purchased commodity code included in the purchase history data in the purchase history data storage unit, with the campaign target commodity code in the campaign target commodity code storage unit, generating a campaign application qualification corresponding to the electronic payment ID data included in the purchase history data including the purchased commodity code which matches the campaign target commodity code, and registering the campaign application qualification data in association with the electronic payment ID data.

The present invention can provide a campaign information processing system which can reduce the troublesome work of a campaign application task performed by a customer and is convenient for the customer.

Moreover, the present invention can provide a campaign information processing system in which a condition of generating the application qualification is changed depending on a purchase condition such as a purchaser condition (purchase-oriented condition) or purchase environmental condition by using a point rule of campaign points as will be described in an embodiment described below, and an effect of the campaign can be increased.

As will be described later, there are other aspects in the present invention. Therefore, this disclosure of the present invention is intended to provide some of the aspects of the present invention, and is not intended to limit the range of the present invention which is described and claimed herein.

### BRIEF DESCRIPTION OF THE DRAWINGS

FIG. 1 is a diagram showing a campaign information processing system according to an embodiment of the present invention along with a relevant configuration;

FIG. 2 is a block diagram showing a configuration of a POS center device;

FIG. 3 is a block diagram showing a configuration of the campaign information processing system;

FIG. 4 is a diagram showing purchase history data in a purchase history data storage unit;

FIG. 5 is a diagram showing a campaign target commodity code storage unit;

FIG. 6 is a diagram showing target person data in a target person data storage unit;

FIG. 7 is a block diagram showing a configuration of a campaign application qualification generation and registration unit;

FIG. 8 is a diagram showing a point rule;

FIG. 9 is a block diagram showing a configuration of a premium grant processing unit;

FIG. 10 is a diagram showing a campaign subscription registration process;

FIG. 11 is a diagram showing another example of the point rule;

FIG. 12 is a diagram showing another example of the point rule;

FIG. 13 is a diagram showing another example of the point rule;

FIG. 14 is a diagram showing another example of the point rule;

FIG. 15 is a diagram showing another example of the point rule; and

FIG. 16 is a diagram showing another example of the point rule.

### BEST MODE FOR CARRYING OUT THE INVENTION

A detailed description of the present invention will be described below. However, the detailed description described below and the accompanying drawings do not limit the present invention. Instead, the range of the present invention is defined by the accompanying claims.

A campaign information processing system of the present invention is a system which performs data processing for generating an application qualification for a premium campaign on a computer. This system is provided with a purchase history data storage unit which stores purchase history data including electronic payment ID data specific to each electronic payment medium and a purchased commodity code which is a commodity code of a purchased commodity, as data on history of purchasing the commodity by using the electronic payment medium; a campaign target commodity code storage unit which stores a campaign target commodity code which is the commodity code of a campaign target commodity of a target campaign; and a campaign application qualification generation and registration unit which compares the purchased commodity code included in the purchase history data in the purchase history data storage unit, with the campaign target commodity code in the campaign target commodity code storage unit, generates a campaign application qualification corresponding to the electronic payment ID data included in the purchase history data including the purchased commodity code which matches the campaign target commodity code, and registers the campaign application qualification data in association with the electronic payment ID data.

According to the present invention, the purchase history data storage unit stores the purchase history data representing a history in which a customer has purchased the commodity by using the electronic payment medium. The purchase history data includes the electronic payment ID data and the purchased commodity code. The electronic payment medium is typically an electronic money medium (an electronic money card, a mobile phone having an electronic money function or the like). The purchased commodity code included in the purchase history data in the purchase history data storage unit is compared with the campaign target commodity code in the campaign target commodity code storage unit. Then, the campaign application qualification data is generated with respect to the electronic payment ID data included in the purchase history data including the purchased commodity code which matches the campaign target commodity code. Then, the campaign application qualification data is registered in association with the electronic payment ID data. In this way, according to the present invention, the customer can obtain the application qualification by purchasing the campaign target commodity by using the electronic payment medium. It is possible to reduce the troublesome work of inputting a campaign code or the like by the customer, and the customer can easily apply for the campaign.

The campaign information processing system of the present invention may be provided with a target person data storage unit which stores at least contact data for communication of each campaign target person and the electronic payment ID data of the electronic payment medium owned by each campaign target person, as data on the campaign target person of the target campaign; an application qualification notification message storage unit which stores an application qualification notification message for notifying the generation of the campaign application qualification; and an application qualification notification unit which, based on the electronic payment ID data and the contact data in the target person data storage unit, transmits the application qualification notification message to the campaign target person by using the contact data corresponding to the electronic payment ID data for which the campaign application qualification data is generated in the campaign application qualification generation and registration unit.

According to the present invention, the contact data and the electronic payment ID data of the campaign target person are stored in the target person data storage unit. Then, when the application qualification is generated, a contact address of the campaign target person for which the application qualification is generated is identified by using the target person data storage unit, and the application qualification notification message is transmitted to the contact address. Therefore, when the application qualification is generated, it is possible to automatically transmit the application qualification notification message to the campaign target person and rapidly notify the generation of the application qualification. Typically, the contact data is an email address, and an email in which the application qualification notification message is described is transmitted.

The campaign information processing system of the present invention may be provided with a target person data storage unit which stores at least contact data for communication of each campaign target person and the electronic payment ID data of the electronic payment medium owned by each campaign target person, as data on the campaign target person of the target campaign, and the campaign application qualification generation and registration unit may be provided with a point rule storage unit which stores a point rule which prescribes campaign points to be granted depending on the purchase of the campaign target commodity; a point decision unit which decides the campaign points to be granted with respect to the electronic payment ID data included in the purchase history data including the purchased commodity code which matches the campaign target commodity code, according to the point rule in the point rule storage unit; a point registration unit which registers the campaign points decided by the point decision unit, in the target person data storage unit, in association with the electronic payment ID data; a qualification generation determination unit which determines that the campaign application qualification is generated, when the campaign points stored in the target person data storage unit reach predetermined application qualification generation points; and a qualification registration unit which, in response to a result of the determination in the qualification generation determination unit, registers the campaign application qualification data in the target person data storage unit, in association with the electronic payment ID data for which the campaign application qualification is generated.

According to the present invention, when the campaign target person has purchased the campaign target commodity, the campaign points are accumulated at the system side of the present invention. Then, at the system side, it is determined that the accumulated campaign points have reached application qualification generation premium points, and the application qualification is granted by computer processing. In this way, data processing for a campaign of a point accumulation type can be preferably realized. The customer can easily accumulate the points and obtain the application qualification by purchasing the campaign target commodity by using the electronic payment medium.

The campaign information processing system of the present invention may include a target person data storage unit which stores at least contact data for communication of each campaign target person and the electronic payment ID data of the electronic payment medium owned by each campaign target person, as data on the campaign target person of the target campaign; and a campaign subscription registration processing unit which accepts an input of the electronic payment ID data retained by a subscriber for participation in the target campaign, regards the subscriber for the participation as the campaign target person, and registers the electronic payment ID data in the target person data storage unit. According to this configuration, the campaign target person can be registered by a subscription process. In the registration of the subscription, a blank email or a Web site for the subscription can be preferably used.

The point rule storage unit may store, as the point rule, the campaign target commodity and a value of the campaign points to be granted by the purchase of the campaign target commodity. Data on the campaign target commodity may be data for identifying a target manufacturer (maker), and in this case, a commodity of the target manufacturer becomes the campaign target commodity. Moreover, the point rule may prescribe the value of the campaign points to be granted depending on a quantity of purchase or a purchased amount of money of the campaign target commodity.

Moreover, the target person data storage unit may stored attribute data of the campaign target person in association with the electronic payment ID data; in the point rule in the point rule storage unit, the value of the campaign points may be set to be different depending on attributes of the campaign target person; and the point decision unit may read the attribute data in the target person data storage unit, and may decide the campaign points according to the point rule, based on the attribute data.

According to this configuration, the value of the campaign points to be granted can be changed depending on a purchaser condition (purchase-oriented condition) like what kind of attribute the campaign target person who purchases the campaign target commodity has. Therefore, a condition of generating the application qualification can be changed depending on the purchase-oriented condition. For example, the campaign points to be granted when the campaign target person having an attribute of a strategic target for the campaign target commodity purchases the campaign target commodity can be set to large. Thereby, it is possible to increase the willingness of a target customer to purchase, and increase an effect of the campaign.

An example of the attribute is sex (or gender). In this case, the target person data storage unit may store sex data as the attribute data, and in the point rule, the value of the campaign points may be set to be different depending on sex of the campaign target person.

Another example of the attribute is age. In this case, the target person data storage unit may store age data as the attribute data, and in the point rule, the value of the campaign points may be set to be different depending on age of the campaign target person.

Moreover, the point rule storage unit may store combination campaign points corresponding to a combination of predetermined multiple campaign target commodities, as the point rule, and the point decision unit may obtain a value of the combination campaign points according to the point rule when the predetermined multiple campaign target commodities prescribed in the point rule are purchased in combination.

According to this configuration, the value of the campaign points to be granted can be changed depending on a purchase condition like what kinds of campaign target commodities are purchased in combination. Therefore, the condition of generating the application qualification can be changed depending on the purchase condition. It is possible to perform cross-sell by changing the campaign points depending on the combination of the commodities, and increase the effect of the campaign due to an effect of the cross-sell.

Moreover, the purchase history data storage unit may further store date and time of purchase data as the purchase history data; in the point rule in the point rule storage unit, the value of the campaign points may be set to be different depending on date and time of purchase of the campaign target commodity; and the point decision unit may read the date and time of purchase data in the purchase history data in the purchase history data storage unit, and may obtain the campaign points according to the point rule, based on the date and time of purchase data.

According to this configuration, it is possible to handle the date and time of purchase as a purchase environmental condition, and change the value of the campaign points to be granted, depending on the date and time of purchase. Therefore, the condition of generating the application qualification can be changed depending on the purchase environmental condition. It is possible to increase the effect of the campaign by promoting strategically the purchase at a specific day of the week or period of time.

Moreover, the purchase history data storage unit may further store place of purchase data as the purchase history data; in the point rule in the point rule storage unit, the value of the campaign points may be set to be different depending on a place of purchase of the campaign target commodity; and the point decision unit may read the place of purchase data in the purchase history data in the purchase history data storage unit, and may obtain the campaign points according to the point rule, based on the place of purchase data.

According to this configuration, it is possible to handle the place of purchase as the purchase environmental condition, and change the value of the campaign points to be granted, depending on the place of purchase. Therefore, the condition of generating the application qualification can be changed depending on the purchase environmental condition. It is possible to increase the effect of the campaign by promoting strategically the purchase at a specific place.

The present invention may be represented by an aspect other than the above described campaign information processing system. For example, another aspect of the present invention is a campaign information processing method which performs data processing for generating an application qualification for a premium campaign on a computer. In this method, a purchase history data storage unit configured with storage means of the computer stores purchase history data including electronic payment ID data specific to each electronic payment medium and a purchased commodity code which is a commodity code of a purchased commodity, as data on history of purchasing the commodity by using the electronic payment medium; a campaign target commodity code storage unit configured with the storage means of the computer stores a campaign target commodity code which is the commodity code of a campaign target commodity of a target campaign; and the campaign information processing method compares the purchased commodity code included in the purchase history data in the purchase history data storage unit, with the campaign target commodity code in the campaign target commodity code storage unit, generates a campaign application qualification corresponding to the electronic payment ID data included in the purchase history data including the purchased commodity code which matches the campaign target commodity code, and registers the campaign application qualification data in association with the electronic payment ID data. Advantages of the present invention can also be obtained according to this aspect. Also in this aspect, various configurations which are described with respect to the above described campaign information processing apparatus can be employed, and advantages of the various configurations can be obtained.

Another aspect of the present invention is a campaign information processing program which causes a computer to execute data processing for generating an application qualification for a premium campaign. This program causes the computer to execute a process of causing a purchase history data storage unit configured with storage means of the computer to store purchase history data including electronic payment ID data specific to each electronic payment medium and a purchased commodity code which is a commodity code of a purchased commodity, as data on history of purchasing the commodity by using the electronic payment medium; causing a campaign target commodity code storage unit configured with the storage means of the computer to store a campaign target commodity code which is the commodity code of a campaign target commodity of a target campaign; and comparing the purchased commodity code included in the purchase history data in the purchase history data storage unit, with the campaign target commodity code in the campaign target commodity code storage unit, generating a campaign application qualification corresponding to the electronic payment ID data included in the purchase history data including the purchased commodity code which matches the campaign target commodity code, and registering the campaign application qualification data in association with the electronic payment ID data. The advantages of the present invention can also be obtained according to this aspect. Also in this aspect, the various configurations which are described with respect to the above described campaign information processing apparatus can be employed, and the advantages of the various configurations can be obtained.

The campaign information processing system of an embodiment of the present invention will be described below by using the drawings.

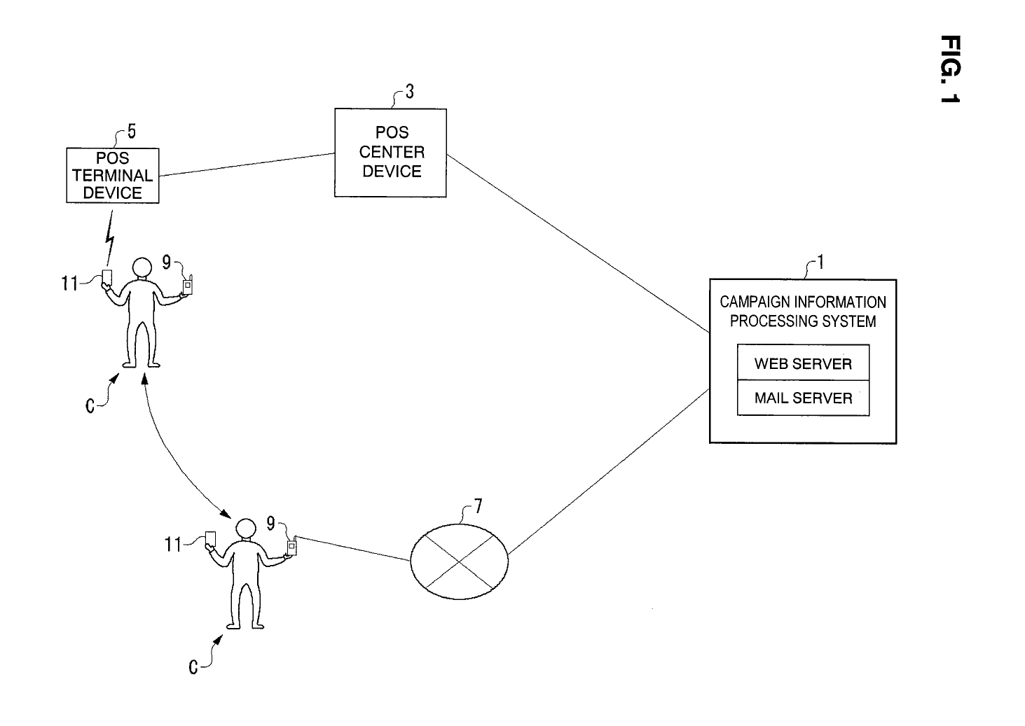

FIG. 1 shows the campaign information processing system according to this embodiment along with a relevant configuration. A campaign information processing system 1 is a computer system configured with one or more computers.

The campaign information processing system 1 has a communication function, and is connected to a POS (Point Of Sales) center device 3. Furthermore the POS center device 3 is connected to a POS terminal device 5 in a retail store (the POS (Point Of Sales) is a system capable of aggregating sales results of sales of goods for each single item). Although one POS terminal device 5 is shown in the figure, in practice, multiple POS terminal devices 5 are communicably connected to the POS center device 3.

The campaign information processing system 1 has functions of a WEB server and a mail server, and is connected to a mobile phone 9 of a customer via the Internet 7. The mobile phone 9 is one form of a customer terminal device used by a customer C. The customer terminal device is not limited to the mobile phone 9, and for example, may be a mobile terminal or a personal computer.

The customer C possesses an electronic money card 11 along with the mobile phone 9. The customer goes to the retail store and uses the electronic money card 11 to purchase a commodity. The POS terminal device 5 is provided at a cash register device in the retail store, and has an electronic money handling function, reads and writes data with respect to the electronic money card 11.

The electronic money card 11 is one form of the electronic payment (settlement) medium of the present invention. The electronic money card 11 may be integrated with the mobile phone 9. The mobile phone having the electronic money function may serve as both the mobile phone 9 and the electronic money card 11 of FIG. 1. Within the range of the present invention, the electronic payment medium is not limited to the electronic money card. The electronic payment medium may be a medium for credit payment. The electronic payment medium may be a card used for boarding in transportation facilities.

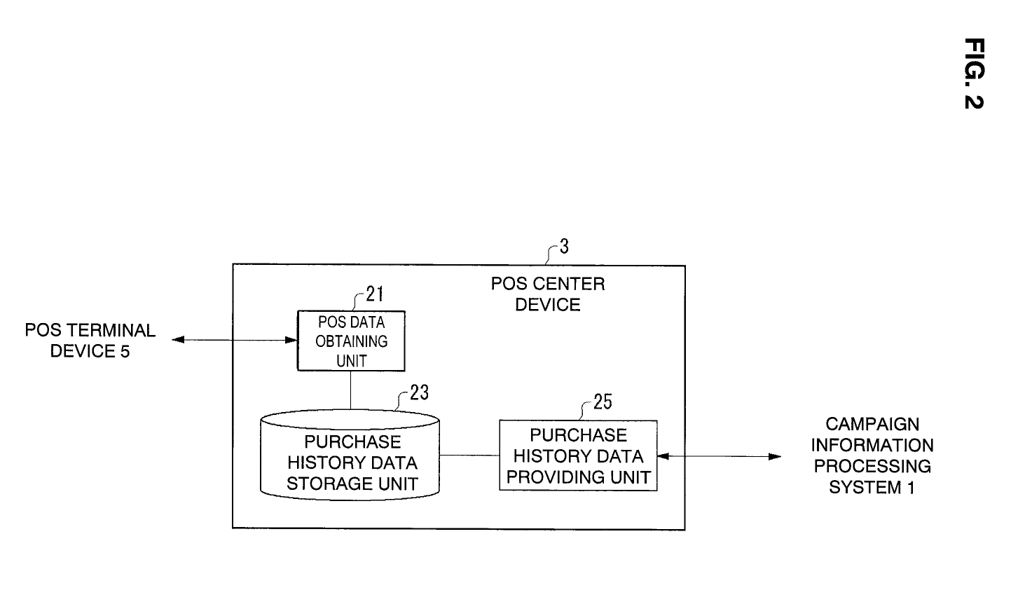

FIG. 2 shows a configuration of the POS center device 3. The POS center device 3 has a function of communicating with the POS terminal device 5 and the campaign information processing system 1. The POS center device 3 is configured with a POS data obtaining unit 21, a purchase history data storage unit 23 and a purchase history data providing unit 25.

The POS data obtaining unit 21 uses the communication function to obtain POS data from the POS terminal device 5. When the commodity is purchased by using the electronic money card 11, the POS terminal device 5 reads an electronic money number from the electronic money card 11. The electronic money number is a unique number assigned to each electronic money card 11, and is one form of the electronic payment (settlement) ID data of the present invention. The POS terminal device 5 further reads the commodity code of the purchased commodity with a function of the cash register device, records the POS data including data on the electronic money number, the commodity code, the date and time of purchase, the quantity of purchase, the purchased amount of money and a store of purchase, and further transmits the POS data to the POS center device 3. In the POS center device 3, the POS data obtaining unit 21 obtains the POS data and stores the obtained POS data as the purchase history data in the purchase history data storage unit 23.

The purchase history data providing unit 25 has a server function. The purchase history data providing unit 25 uses the function of communicating with the campaign information processing system 1 to receive a request for transmission of the purchase history data, from the campaign information processing system 1. Then, in response to the transmission request from the campaign information processing system 1, the purchase history data providing unit 25 reads the purchase history data from the purchase history data storage unit 23 and transmits the purchase history data to the campaign information processing system 1. Incidentally, the purchase history data providing unit 25 may be configured to transmit the purchase history data to the campaign information processing system 1 without the transmission request from the campaign information processing system 1.

In this embodiment, as described above, the POS center device 3 is provided, and the purchase history data is provided from the POS terminal device 5 via the POS center device 3 to the campaign information processing system 1. As a variation, the campaign information processing system 1 and the POS terminal device 5 may be directly connected to each other, and the POS terminal device 5 may directly transmit the POS data as the purchase history data to the campaign information processing system 1.

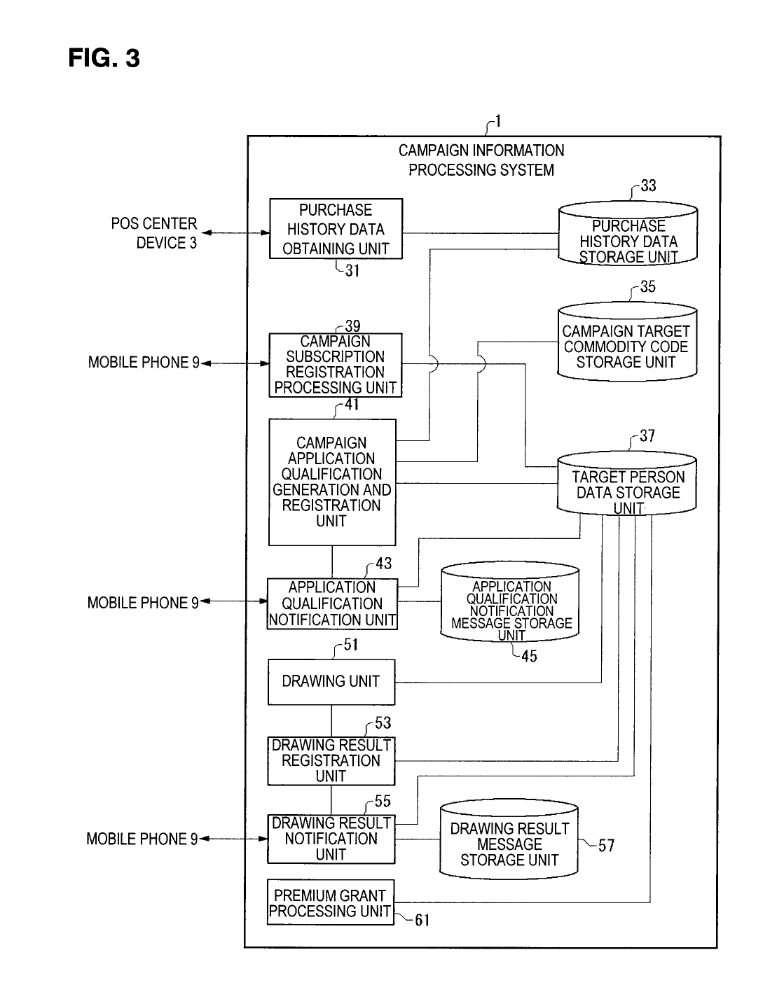

FIG. 3 shows a configuration of the campaign information processing system 1. Respective components and functions of FIG. 3 are realized by the storage means, process execution means and input/output means of the computer, when the computer of the campaign information processing system 1 executes programs. The functions of the campaign information processing system 1 may be realized by an ASP.

As shown, the campaign information processing system 1 is provided with a purchase history data obtaining unit 31 which obtains the purchase history data through the communication from the POS center device 3, a purchase history data storage unit 33 which stores the purchase history data, a campaign target commodity code storage unit 35 which stores the campaign target commodity code of the target campaign, a target person data storage unit 37 which stores the data on the campaign target person, a campaign subscription registration processing unit 39 which accepts a subscription to participate in the target campaign and registers the campaign target person in the target person data storage unit 37, a campaign application qualification generation and registration unit 41 having a function of generating the campaign application qualification based on the purchase history data and the like and registering the campaign application qualification, and an application qualification notification unit 43 which notifies the application qualification generation. The application qualification notification unit 43 transmits the application qualification notification message stored in an application qualification notification message storage unit 45. Moreover, not only the application qualification generation but also a notification of game participation and the like may be transmitted.

The campaign information processing system 1 is further provided with a drawing (lottery) unit 51 which performs drawing for the campaign target person for which the application qualification has been generated, a drawing result registration unit 53 which registers a drawing result, and a drawing result notification unit 55 which notifies the drawing result. The drawing result notification unit 55 transmits a drawing result message stored in a drawing result message storage unit 57. Furthermore, the campaign information processing system 1 is provided with a premium grant processing unit 61 which performs a process of granting a premium with respect to a winner.

Hereinafter, configurations of the respective units in the campaign information processing system 1 will be described.

The purchase history data obtaining unit 31 transmits the request for the transmission of the purchase history data with respect to the purchase history data providing unit 25 in the POS center device 3, receives the purchase history data from the purchase history data providing unit 25, and stores the received purchase history data in the purchase history data storage unit 33.

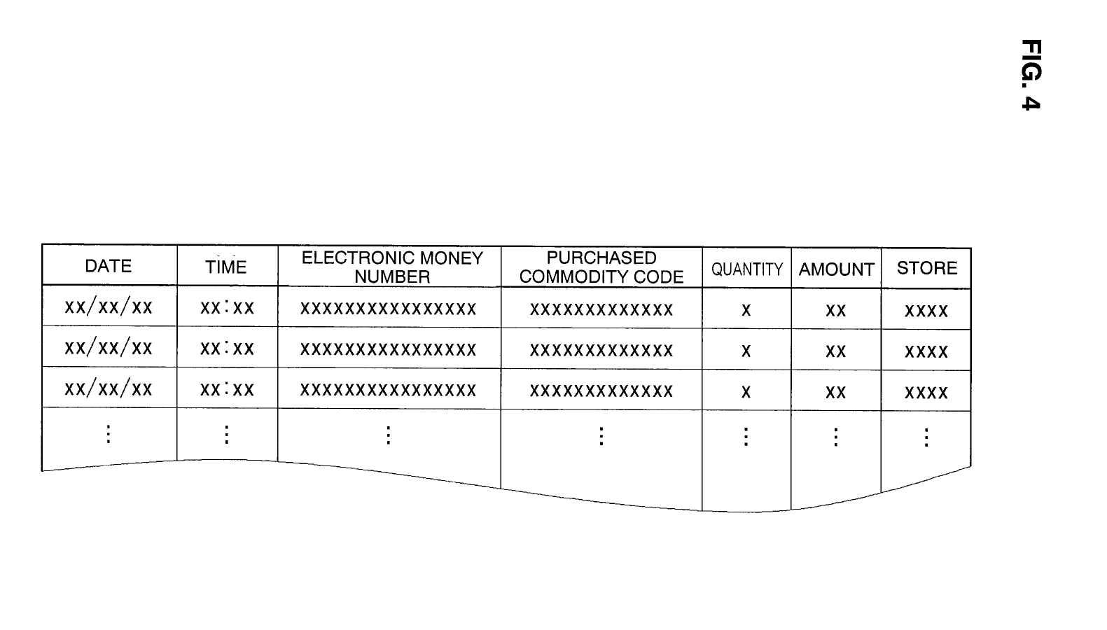

FIG. 4 shows the purchase history data to be stored in the purchase history data storage unit 33. As shown, the purchase history data includes the date and time of purchase, the electronic money number, the purchased commodity code, the quantity of purchase, the purchased amount of money, and the store of purchase. The purchased commodity code is the commodity code of the purchased commodity. The commodity code is a unique code assigned to each commodity. The commodity code may be so-called JAN code (the JAN (Japan Article Number) code is a code standardized by JIS and is used in Japan. Other codes may be used in respective countries. For example, UPC (Universal Product Code) is used in America/Canada, and EAN (European Article Number) is used in Europe). The commodity code may be an appropriate code other than the JAN code. The store of purchase is one form of the place of purchase data of the present invention. Store data is a store code which is specific to each store. In addition to the above described various data, the purchase history data may further include other data and such data may be utilized for marketing and the like.

The campaign target commodity code storage unit 35 stores the campaign target commodity code of the target campaign. The campaign target commodity code is the commodity code of the campaign target commodity.

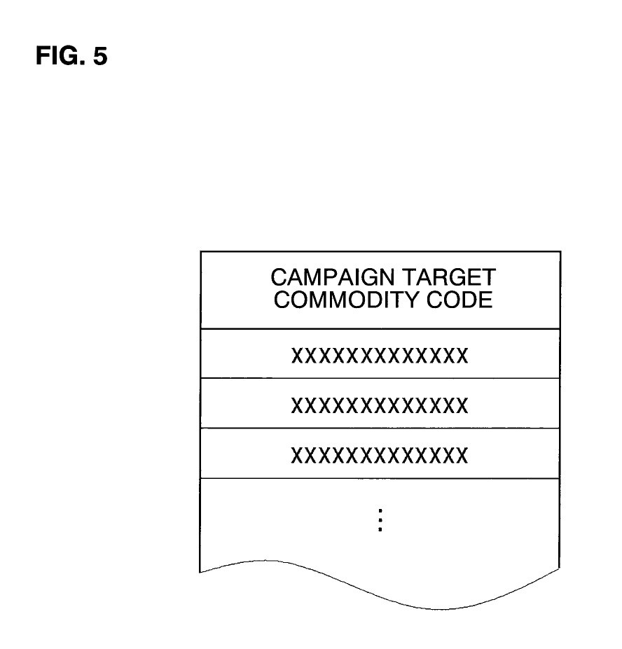

FIG. 5 is an example of the campaign target commodity code storage unit 35. In the example of FIG. 5, multiple commodities are specified as the campaign target commodities, and multiple campaign target commodity codes are stored. However, within the range of the present invention, the campaign target commodity may be one kind. In this case, one campaign commodity code may be stored.

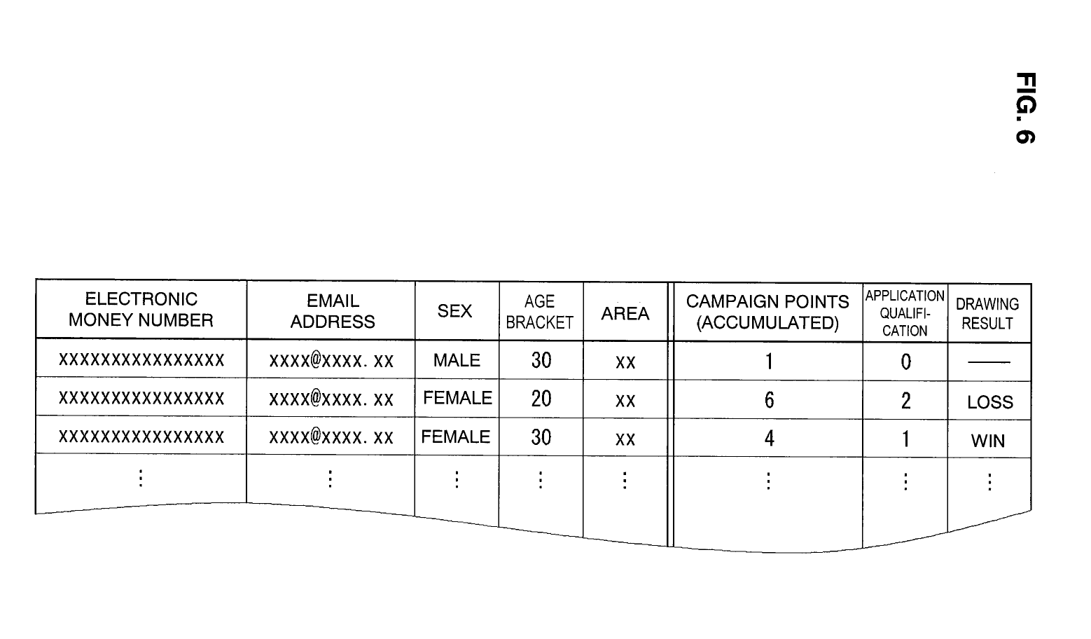

FIG. 6 shows an example of the target person data storage unit 37. The target person data storage unit 37 stores data on the electronic money card number, the email address, the sex (gender), an age bracket and a residential area, as the data on the campaign target person. The email address is one form of the contact data of the campaign target person, and the age bracket is one form of the age data of the campaign target person. These data are accepted by the campaign subscription (application) registration processing unit 39 and registered in the target person data storage unit 37. The campaign subscription registration processing unit 39 accepts the above described electronic money number and the like from the mobile phone 9 of the customer who is the subscriber (applicant) for the participation in the target campaign.

The target person data storage unit 37 further stores data on the campaign points, the application qualification and the drawing result, as data to be recorded as the campaign proceeds. The campaign points are recorded when the campaign target commodity is purchased. The application qualification data is recorded when the application qualification is generated with the purchase of the campaign target commodity. Furthermore, the drawing result data is data on the result of the drawing performed after the application qualification has been generated.

The campaign application qualification generation and registration unit 41 compares the purchased commodity code included in the purchase history data in the purchase history data storage unit 33, with the campaign target commodity code in the campaign target commodity code storage unit 35, and generates the campaign application qualification with respect to the electronic money number included in the purchase history data including the purchased commodity code which matches the campaign target commodity code. More particularly, when the campaign application qualification generation and registration unit 41 detects the purchased commodity code which matches the campaign target commodity code, the campaign application qualification generation and registration unit 41 accumulates the campaign points for the appropriate or relevant electronic money number. Then, when the campaign points have been accumulated enough, the campaign application qualification generation and registration unit 41 generates the application qualification for the appropriate electronic money number. Then, the campaign application qualification generation and registration unit 41 registers the campaign application qualification data in association with the appropriate electronic money number. The registration of the campaign application qualification is performed with respect to the target person data storage unit 37.

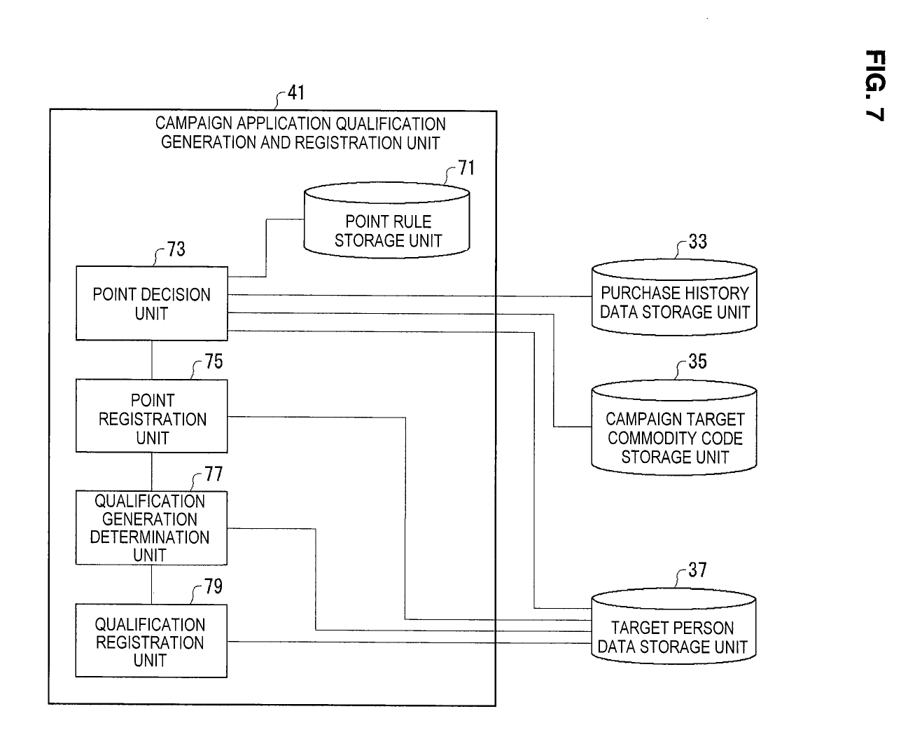

FIG. 7 shows a configuration of the campaign application qualification generation and registration unit 41. The campaign application qualification generation and registration unit 41 is configured with a point rule storage unit 71, a point decision unit 73, a point registration unit 75, a qualification generation determination unit 77 and a qualification registration unit 79.

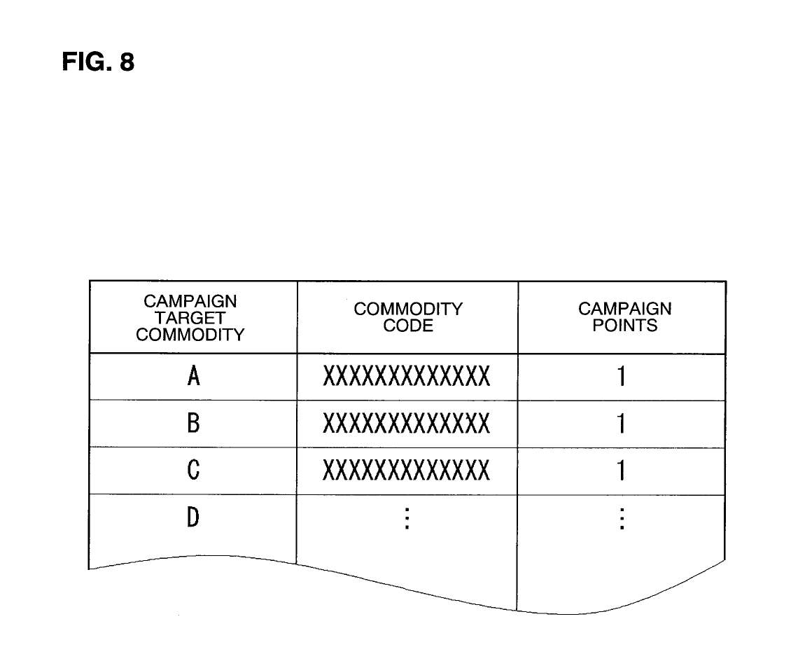

The point rule storage unit 71 stores the point rule which prescribes the campaign points to be granted depending on the purchase of the campaign target commodity. FIG. 8 shows an example of the point rule. In the example of FIG. 8, the point rule is a value of the campaign points to be granted with the purchase of each campaign target commodity. The point rule storage unit 71 stores the campaign points in association with the commodity code of the campaign target commodity. In FIG. 8, the campaign points for all campaign target commodities are same. However, the campaign points may be different depending on the commodity. The point rule storage unit 71 may be integrated with the campaign target commodity code storage unit 35.

The point decision unit 73 decides the campaign points to be granted with respect to the electronic money number included in the purchase history data including the purchased commodity code which matches the campaign target commodity code, according to the point rule in the point rule storage unit 71.

More particularly, the point decision unit 73 refers to the target person data storage unit 37 and the purchase history data storage unit 33, and identifies a purchase history including the electronic money number registered in the target person data storage unit 37, from the purchase history data storage unit 33. Furthermore, the point decision unit 73 refers to the purchase history data storage unit 33 and the campaign target commodity code storage unit 35, and identifies a purchase history including the purchased commodity code which matches the campaign target commodity code. Then, the point decision unit 73 decides the campaign points from the purchase histories, according to the point rule. For example, if the quantity of purchase is n, the campaign points set in the point rule are multiplied by n. The customer to be granted with these campaign points is identified by the electronic money number included in the purchase history.

The point registration unit 75 registers the campaign points decided by the point decision unit 73, in the campaign subscription registration processing unit 39. The campaign points are registered in the campaign subscription registration processing unit 39, in association with the appropriate electronic money number. In this registration process, the campaign points which are newly decided are added to the campaign points which have been previously accumulated.

When the campaign points stored in the target person data storage unit 37 have reached the predetermined application qualification generation points, the qualification generation determination unit 77 determines that the campaign application qualification is generated. The application qualification generation points have been previously set and stored in the campaign information processing system 1. When the campaign points are recorded in the target person data storage unit 37, the qualification generation determination unit 77 reads the accumulated campaign points from the target person data storage unit 37, and determines whether or not the campaign points have reached the application qualification generation points. The qualification generation determination unit 77 may periodically perform the above described determination process.

In response to a result of the determination in the qualification generation determination unit 77, the qualification registration unit 79 registers the campaign application qualification data in the target person data storage unit 37. The campaign application qualification data is registered in association with the electronic money number for which the campaign application qualification is been generated. When the campaign points have been accumulated, the application qualification is generated more than once. In this case, as shown in FIG. 6, the number of application qualifications (the number of times of generation, the number of qualifications) may be recorded.

Returning to FIG. 3, the application qualification notification unit 43 has a function of notifying the campaign target person of the generation of the campaign application qualification. The application qualification notification unit 43 uses the mail server function of the campaign information processing system 1 to realize the communication function.

The application qualification notification unit 43 refers to the data in the target person data storage unit 37 and reads the email address corresponding to the electronic money number for which the campaign application qualification is generated. Moreover, the application qualification notification unit 43 reads the application qualification notification message for notifying the generation of the campaign application qualification, from the application qualification notification message storage unit 45. Then, the application qualification notification unit 43 generates the email in which the application qualification notification message is described, and transmits the email to the email address read from the target person data storage unit 37. The email address is an example of the contact data of the present invention. Within the range of the present invention, the contact data is not limited to the email address. The contact data may be data other than the email address if the message can be electronically transmitted.

The application qualification notification unit 43 is preferably informed of the generation of the application qualification by the campaign application qualification generation and registration unit 41. At this time, the electronic money number for which the application qualification is generated may be informed. Then, when the application qualification notification unit 43 accepts the notification of the electronic money number, the application qualification notification unit 43 transmits the email to the email address corresponding to the informed electronic money number as described above. Thereby, the application qualification is immediately notified at the same time as it is generated.

The above described process of notifying the application qualification may be periodically performed at suitable intervals. Also in this case, the intervals of the notification process are preferably set to be short. Thereby, the generation of the qualification is rapidly notified.

The drawing unit 51 performs the drawing for the campaign target person for which the application qualification has been generated. For example, the drawing unit 51 periodically performs the drawing as described below. When a timing of the drawing comes, the drawing unit 51 refers to the target person data storage unit 37 and identifies the electronic money number for which the application qualification has been generated. The drawing unit 51 performs the drawing by using random numbers, and identifies electronic money numbers of a predetermined number of winners, from electronic money numbers having the application qualification.

The drawing result registration unit 53 registers the drawing result in the target person data storage unit 37. Win or loss is recorded in association with each electronic money number.

The drawing result notification unit 55 transmits the drawing result message. The drawing result messages are stored in the drawing result message storage unit 57. The drawing result message storage unit 57 stores the drawing result message for the winner and the drawing result message for a loser.

The drawing result notification unit 55 reads the email address corresponding to the electronic money number for which the win is registered, from the target person data storage unit 37, generates and transmits an email in which the drawing result message for the winner is described. Similarly, the drawing result notification unit 55 reads the email address corresponding to the electronic money number for which the loss is registered, from the target person data storage unit 37, generates and transmits an email in which the drawing result message for the loser is described.

The premium grant processing unit 61 performs the process of granting the premium with respect to the winner of the drawing by the drawing unit 51.

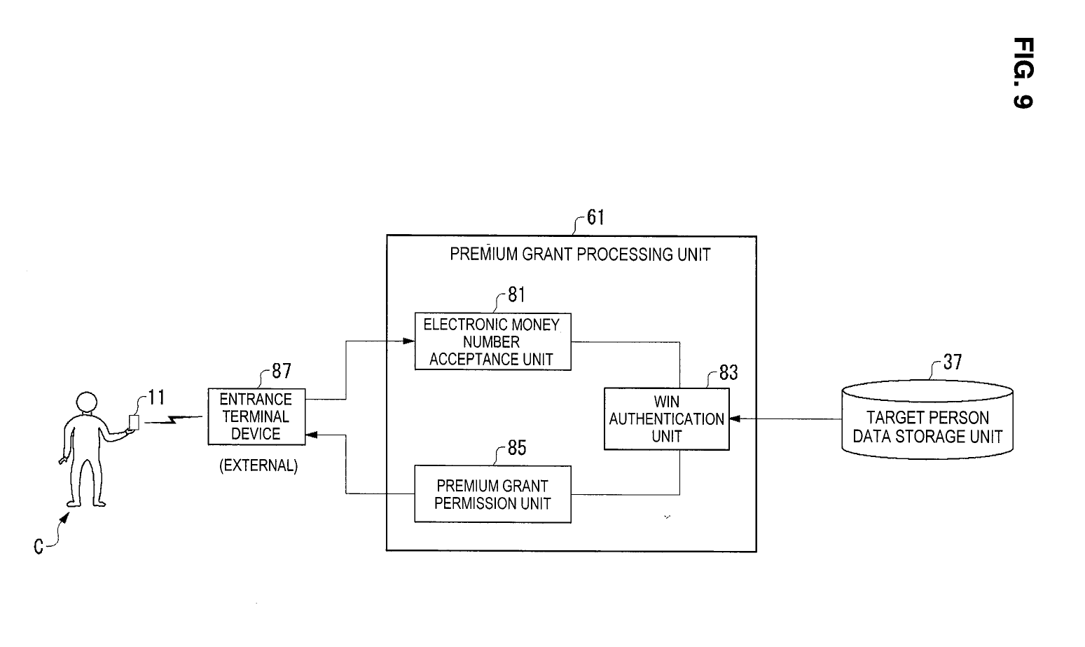

FIG. 9 shows a configuration example of the premium grant processing unit 61. In the example of FIG. 9, the premium is electronically granted. Here, as an example, it is assumed that the premium is a movie ticket.

The premium grant processing unit 61 is configured with an electronic money number acceptance unit 81, a win authentication unit 83 and a premium grant permission unit 85. The electronic money number acceptance unit 81 receives and accepts the electronic money number through the communication from an entrance management computer 87 in a movie theater.

The entrance management computer 87 is installed in the movie theater, and reads the electronic money number from the electronic money card 11 of the customer and transmits the electronic money number to the campaign information processing system 1. When the electronic money number acceptance unit 81 accepts the electronic money number, the win authentication unit 83 refers to the target person data storage unit 37 and performs an authentication process. The win authentication unit 83 verifies whether or not the win of the accepted electronic money number is recorded in the target person data storage unit 37. If the loss is recorded, the authentication results in failure. Also if the accepted electronic money number is not registered in the target person data storage unit 37, the authentication results in failure. If the appropriate electronic money number is recorded in the target person data storage unit 37 and its win is recorded, the authentication succeeds. When the authentication succeeds, the premium grant permission unit 85 transmits a permission of granting the premium, to the entrance management computer 87. Thereby, in the movie theater, the customer is permitted to enter the movie theater.

Here, conventionally and generally, in a system for providing an electronic ticket, electronic ticket data is written in a medium. In contrast to this, in the above described example, the premium is granted according to the authentication using the electronic money number. It is unnecessary to perform such a process of recording the electronic ticket data within the mobile phone 9 through the communication with the mobile phone 9 when the win is notified. Therefore, the premium can be easily provided.

In FIG. 9, the electronic money number is transmitted from the entrance management computer 87 to the campaign information processing system 1. In another example, the electronic money number of the winner may be transmitted to the entrance management computer 87 and the authentication process may be performed in the entrance management computer 87. The entrance management computer 87 stores the received electronic money number, reads the electronic money number from the electronic money card 11, and collates the electronic money number with the stored electronic money number. In this configuration, the entrance management computer 87 functions as a premium grant processing unit and configures a part of the campaign information processing system 1.

Hereinabove, the configurations of the respective units of this embodiment have been described. Next, operations of the campaign information processing system 1 of this embodiment will be described. Here, the case where the customer C participates in the campaign is taken as an example.

When the customer C participates in the campaign, the customer C registers the subscription (or application) for the participation, with respect to the campaign information processing system 1. As described below, this subscription for the participation is accepted by the campaign subscription registration processing unit 39 by using the WEB server function of the campaign information processing system 1, and registered in the target person data storage unit 37.

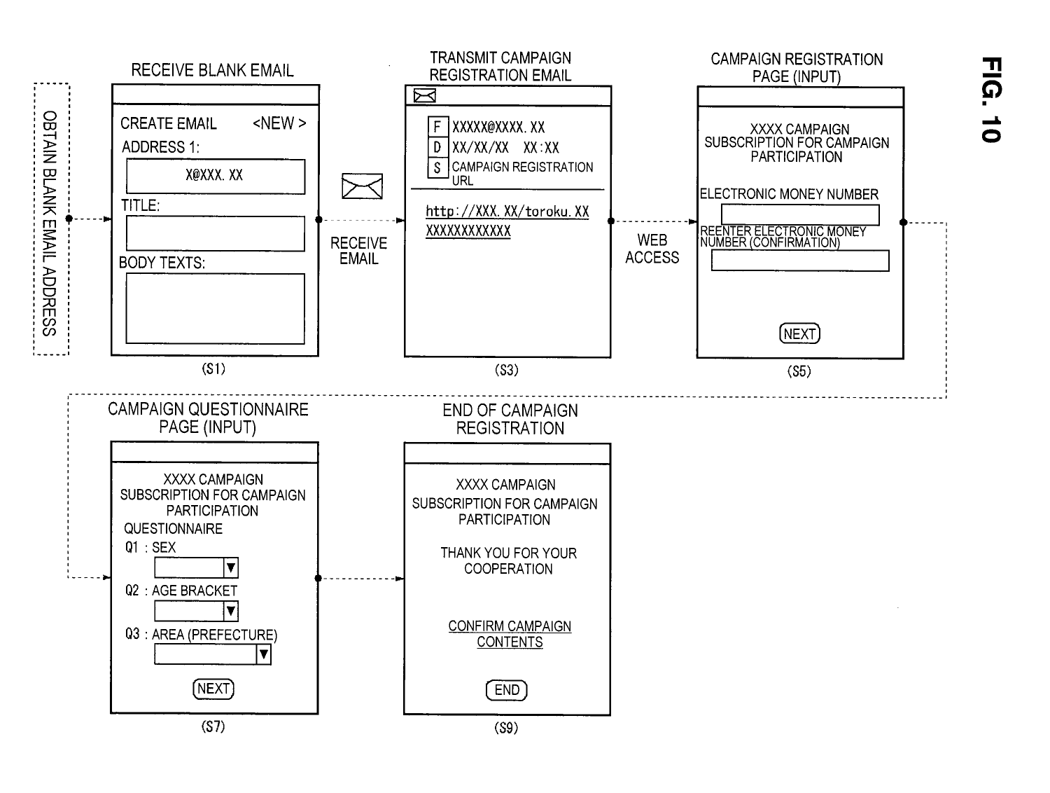

FIG. 10 shows a process in the campaign subscription registration processing unit 39. FIG. 10 is a diagram of a screen of the mobile phone 9 of the customer C. The customer C uses the mobile phone 9 to transmit the blank email to an email address for the campaign subscription. The blank email is an email in which a title and body texts are not described (more particularly, the blank email is an email without a subject line and the body texts transmitted from a mobile phone or the like to a specified email address, and an email including a URL of a WEB site having intended information is returned by transmitting the blank email). The campaign subscription registration processing unit 39 uses the mail server function to receive the blank email from the mobile phone 9 of the customer C who is the subscriber for the participation (S1).

When the campaign subscription registration processing unit 39 receives the blank email, the campaign subscription registration processing unit 39 returns a campaign registration email in which a campaign registration URL is described to the mobile phone 9 (S3). The campaign registration URL is set to be different for each received email address. When the mobile phone 9 accesses the campaign registration URL in the campaign registration email, the campaign subscription registration processing unit 39 uses the WEB server function to accept an input of the electronic money number (S5), and further accepts inputs of the sex, the age bracket and the residential area (S7). Then, the campaign subscription registration processing unit 39 registers the electronic money card number, the email address, the sex, the age bracket and the residential area, in the target person data storage unit 37. When the registration process is completed, the campaign subscription registration processing unit 39 transmits a message of the completion of the registration to the mobile phone 9 (S9).

When the customer C purchases the commodity at the store by using the electronic money card 11, the POS terminal device 5 reads the electronic money number from the electronic money card 11, and transmits the POS data to the POS center device 3. The POS data includes the data on the electronic money number, the commodity code, the date and time of purchase, the quantity of purchase, the purchased amount of money and the store of purchase. The POS data is stored as the purchase history data in the purchase history data storage unit 23 by the POS data obtaining unit 21 in the POS center device 3.

In the campaign information processing system 1, the purchase history data obtaining unit 31 obtains the purchase history data from the POS center device 3. The purchase history data obtaining unit 31 requests the purchase history data providing unit 25 in the POS center device 3 to transmit the purchase history. In response to the transmission request, the purchase history data providing unit 25 reads the purchase history data from the purchase history data storage unit 23 and transmits the purchase history data to the campaign information processing system 1. Then, the purchase history data is obtained by the purchase history data obtaining unit 31 and stored in the purchase history data storage unit 33.

If the customer C purchases the campaign target commodity, the purchase history of the campaign target commodity is obtained and stored in the purchase history data storage unit 33. In this case, as described below, the campaign application qualification generation and registration unit 41 records the campaign points in the target person data storage unit 37.

The campaign application qualification generation and registration unit 41 identifies the purchase history including the electronic money number of the campaign target person from the electronic money number in the purchase history data in the purchase history data storage unit 33 and the electronic money number of the campaign target person in the target person data storage unit 37. Then, the point decision unit 73 decides the campaign points as described above, from the purchase history including the electronic money number registered in the target person data storage unit 37. The point decision unit 73 compares the purchased commodity code in the purchase history data storage unit 33 with the campaign target commodity code in the campaign target commodity code storage unit 35, and identifies the purchase history including the purchased commodity code which matches the campaign target commodity code. Then, the point decision unit 73 decides the campaign points from the purchase history, according to the point rule.

The point registration unit 75 registers the campaign points in the campaign subscription registration processing unit 39. The campaign points are added to the campaign points for the appropriate electronic money number.

Each time the customer C purchases the campaign target commodity, the campaign points for the electronic money number of the electronic money card owned by the customer C increase in the target person data storage unit 37. As a result of accumulating the campaign points, it is assumed that the campaign points have reached the application qualification generation points.

When the campaign points have reached the application qualification generation points, the qualification generation determination unit 77 in the campaign application qualification generation and registration unit 41 determines that the application qualification is generated. When the application qualification is generated, the qualification registration unit 79 registers the campaign application qualification data in the target person data storage unit 37. Furthermore, the application qualification notification unit 43 notifies the campaign target person of the generation of the campaign application qualification. The application qualification notification unit 43 reads the application qualification notification message from the application qualification notification message storage unit 45, and transmits the application qualification notification message to the email address stored in association with the appropriate electronic money number in the target person data storage unit 37.

In this way, after subscribing to participate in the campaign, the customer C can automatically perform a campaign application procedure only by purchasing the campaign target commodity, without particularly performing an application task at the time of purchasing the commodity, and when the application qualification is generated, the customer C can receive the message thereof. Therefore, it is possible to reduce the troublesome task of the application task for the campaign, and improve convenience of the customer.

In addition, in this embodiment, it is unnecessary to register a name, an address and the like in the above described process, and distribution of personal information is suppressed as far as possible. However, within the range of the present invention, for the purpose of the marketing and the like, further information on the customer may be obtained if security is secured.

Moreover, according to this embodiment, a manufacturer (maker)-side can also implement a campaign for commodities of the manufacturer in conjunction with usage of the electronic payment medium such as the electronic money card. Therefore, it is possible to provide a system which is also advantageous to the manufacturer.

Next, a drawing process after the application qualification has been generated will be described. The drawing (lottery) process is performed by the drawing unit 51. The drawing unit 51 identifies the electronic money number for which the application qualification data has been registered, and performs the drawing targeted at the identified electronic money number. Then, the drawing result is registered in the target person data storage unit 37 by the drawing result registration unit 53, and the drawing result is notified by the drawing result notification unit 55.

The drawing result notification unit 55 uses the email addresses in the target person data storage unit 37 to transmit the drawing result messages stored in the drawing result message storage unit 57 to the winner and the loser. In the example of this embodiment, the movie ticket is provided to the winner as the premium. The message for the winner includes a title of a movie, the movie theater and usage of the ticket. In this embodiment, as the usage of the ticket, the winner is required to present the electronic money card 11 in the movie theater.

It is assumed that the customer C won the drawing. According to the message, the customer C goes to the movie theater and causes the entrance management computer 87 to read the electronic money number of the electronic money card 11. The electronic money number is transmitted to the campaign information processing system 1, and accepted by the electronic money number acceptance unit 81 in the premium grant processing unit 61. The win authentication unit 83 performs the authentication of the accepted electronic money number. Here, it is verified whether or not there is the win of the appropriate electronic money number, with reference to the target person data storage unit 37. If the appropriate electronic money number has won, a notification of the permission is transmitted from the premium grant permission unit 85 to the entrance management computer 87. Thereby, the customer C is permitted to enter.

In this way, in this embodiment, it is also possible to easily receive the grant of the premium by using the electronic money card 11, which is convenient.

Also in this process, it is unnecessary to register the name, the address and the like, and the distribution of the personal information is suppressed as far as possible. However, within the range of the present invention, for the purpose of the marketing and the like, the information on the customer may be obtained if the security is secured.

Hereinabove, the operations of the campaign information processing system 1 according to this embodiment have been described. Next, variations and applications of this embodiment will be described.

“Grant of Premium”

In the above described embodiment, the premium is electronically provided to the customer C. In contrast to this, the premium may be an article and may be transmitted to the customer by post or the like. For example, when the message is transmitted to the winner, a URL for the winner is included in the message. When the mobile phone 9 of the customer C accesses the URL for the winner, the customer 9 is required to input the address, the name and a telephone number on a WEB page. This information is accepted by the campaign information processing system 1, and the campaign information processing system 1 performs a process of transmitting a premium commodity to the customer C.

In another example, a message of a delivery method such as a place and a time for delivering the commodity may be provided along with the message of the win. This message may also be displayed on the WEB page of the URL for the winner. At the place for delivering, similarly to the above described ticket, the winner may be authenticated by using the electronic money number.

“Obtaining Purchase History Data”

In this embodiment, the purchase history data is transmitted from the POS center device 3 of FIG. 1 to the campaign information processing system 1. However, the purchase history data may not be transmitted from the POS center device 3 to the campaign information processing system 1. In this case, the purchase history data in the POS center device 3 is used similarly to the purchase history data in the above described internal purchase history data storage unit 33, and the purchase of a campaign target commodity is determined. In this example, the POS center device 3 functions as a part of the campaign information processing system 1. As seen in this example, the configuration of the campaign information processing system 1 may be distributed to multiple places.

The purchase history data obtaining unit 31 may be configured to obtain only the purchase history data of the electronic money number of the campaign target person stored in the target person data storage unit 37 from the POS center device 3, and to store the purchase history data in the purchase history data storage unit 33.

“Point Rule”

In the above described example of FIG. 8, the point rule is the value of the campaign points to be granted depending on the quantity of purchase of the campaign target commodity. More specifically, the point rule is the campaign points to be granted when one campaign target commodity is purchased. As the point rule, various rules which will be illustrated below are further applicable.

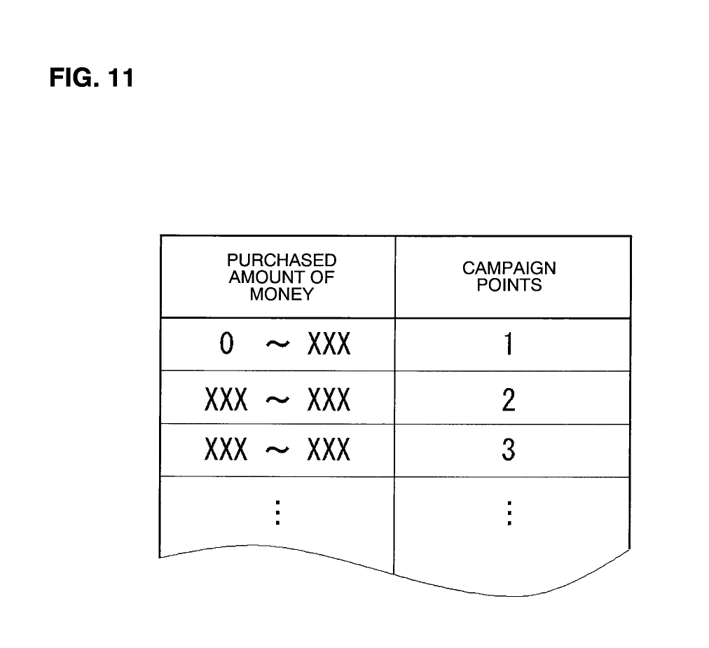

(1) FIG. 11 shows another example of the point rule. In FIG. 11, the point rule is a table of the purchased amount of money and the campaign points. In this way, the point rule may be the value of the campaign points to be granted depending on the purchased amount of the campaign target commodity.

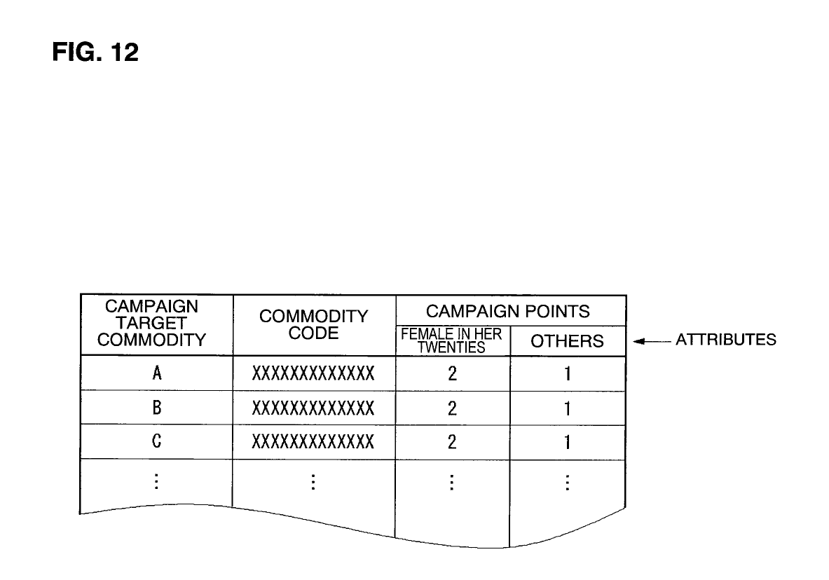

(2) FIG. 12 shows another example of the point rule. Similarly to FIG. 8, FIG. 12 is a table of the campaign points when one campaign target commodity is purchased. However, in FIG. 12, the value of the campaign points is different depending on the attributes of the campaign target person. Specifically, the points for a female in her twenties are set to be twice as large as those for other attributes.

If the point rule of FIG. 12 is applied, when the point decision unit 73 decides the campaign points for the appropriate electronic money number, the point decision unit 73 refers to the sex data and the age bracket data in the target person data storage unit 37, and decides the campaign points depending on the sex and the age bracket.

More particularly, the campaign target commodity code storage unit 35 and the purchase history data storage unit 33 are compared, and the purchase history including the purchased commodity code which matches the campaign target commodity code is identified. Then, the electronic money number in the identified purchase history is searched from the target person data storage unit 37, and the sex data and the age bracket data corresponding to the appropriate electronic money number are referred to. Then, the campaign points depending on the sex and the age bracket are obtained from the point rule of FIG. 12. If the sex is female and the age bracket is twenties, the campaign points which are twice as large as those for other attributes are recorded in the target person data storage unit 37.

In this way, in this embodiment, the point rule is set so that the value of the campaign points is different depending on the attributes of the campaign target person. The point rule may be set so that the campaign points for the attribute of the strategic target for the marketing may become larger than the campaign points for other attributes. Thereby, the campaign points given to the strategic target can be large. Then, it is possible to realize a campaign for purposefully activating the strategic target, and increase the effect of the campaign.

The above described sex and age are examples of the attributes. The attributes are not limited to the above description. Both the sex and the age may not be used. In other words, the campaign points may be different depending on one of the sex and the age.

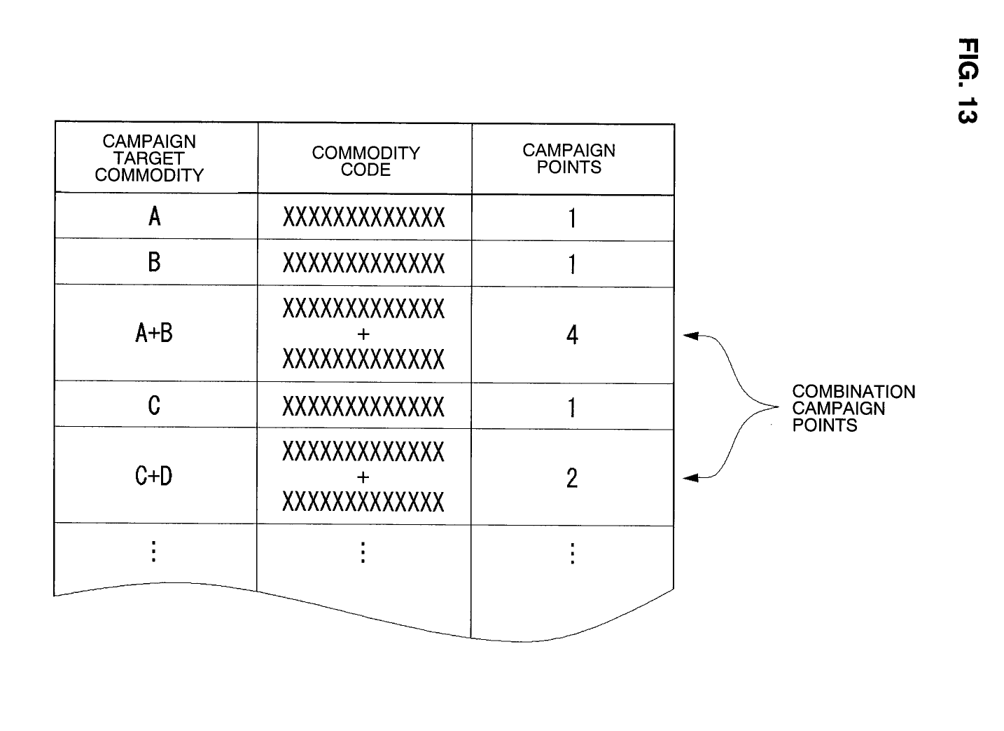

(3) FIG. 13 shows another example of the point rule. In FIG. 13, as the point rule, the combination campaign points corresponding to the combination of the predetermined multiple campaign target commodities are set.

Specifically, the campaign point for a single commodity A is 1 point. Moreover, the campaign point for a single commodity B is also 1 point. In contrast to this, the campaign points for a combination of the commodities A and B are 4 points (twice). Although not shown, a combination of the same commodities A and A can also be set. For example, 3 points are set with respect to two commodities A.

Moreover, the campaign point for a single commodity C is 1 point. Although not shown, the campaign point for a single commodity D is 0 point. In contrast to this, the campaign points for a combination of the commodities C and D are 2 points (twice).

If the point rule of FIG. 13 is applied, when the point decision unit 73 decides the campaign points for the appropriate electronic money number, the point decision unit 73 refers to the purchased commodity code in the purchase history. When the above described multiple commodities are purchased in combination, the point decision unit 73 grants the combination campaign points according to the point rule.

For example, it is assumed that the customer purchases the commodities A and B. The purchase histories of these commodities A and B are simultaneously recorded in the purchase history data storage unit 33. The point decision unit 73 detects from the purchase history data that the commodities A and B are purchased in combination. Then, the point decision unit 73 refers to the point rule of FIG. 13, and obtains 4 points which are the combination campaign points for the commodities A and B. These 4 points are added to the accumulated points for the appropriate electronic money number.

In this way, in this embodiment, the point rule is set so that the value of the campaign points is different depending on the combination of the commodities. It is possible to realize a campaign for purposefully activating the cross-sell which is a marketing strategy, and increase the effect of the campaign (the cross-sell is an approach for recommending, for a purchaser of a certain commodity or a person wishing to purchase the commodity, another commodity or a combined commodity related to the commodity, which leads to increase in sales per customer).

In the marketing, in addition to the cross-sell, up-sell is also effective as a strategy. The cross-sell promotes the purchase of multiple kinds of commodities in combination, whereas the up-sell promotes the purchase of a higher grade commodity (the up-sell is an approach for recommending a more expensive commodity, a high value-added commodity or the like for the purchaser of a certain commodity or the person wishing to purchase the commodity, which leads to the increase in the sales per customer). The up-sell can also be realized by setting the point rule of this embodiment. For example, the higher the grade of the commodity becomes, the larger the campaign points are set to be. A range of increase in the campaign points may be set to be larger than a range of increase in a price due to upgrading. Thereby, it is possible to increase the effect of the campaign by promoting the up-sell.

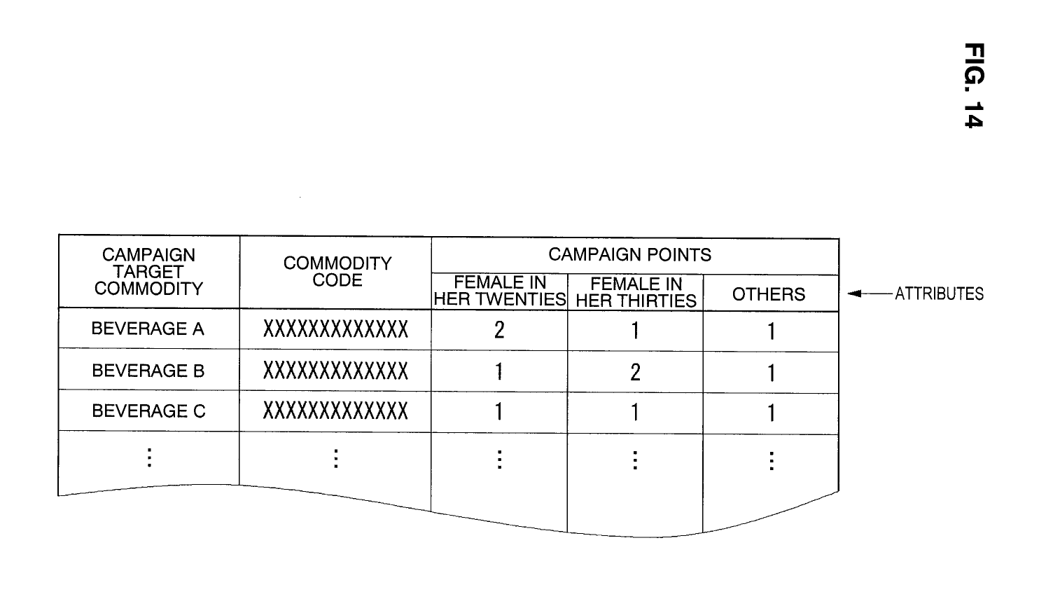

(4) FIG. 14 is an application of the point rule of FIG. 12. In FIG. 14, the campaign points are set to be different depending on a combination of the commodity and the attributes of the campaign target person.

In FIG. 14, as the campaign target commodities, a beverage A and a beverage B are set. With respect to the beverage A, if the attributes are female and twenties, 2 points are given. In the case of other attributes, 1 point is given.

Moreover, with respect to the beverage B, if the attributes are female and thirties, 2 points are given. In the case of other attributes, 1 point is given.

If the point rule of FIG. 14 is applied, when the point decision unit 73 decides the campaign points for the appropriate electronic money number, the point decision unit 73 refers to the purchased commodity code in the purchase history, and refers to the sex data and the age bracket data in the target person data storage unit 37. Then, the point decision unit 73 decides the campaign points depending on a combination of the purchased commodity, the sex and the age bracket, according to the point rule.

In this way, in this embodiment, the point rule is set so that the value of the campaign points is different depending on the kind of the commodity and the attributes of the campaign target person. Thereby, it is possible to activate multi-brand expansion for the target. In the above described example, it is assumed that both the beverages A and B are provided by one manufacturer X. In this case, the manufacturer X can promote the sales of both the beverage A for the female in her twenties and the beverage B for the female in her thirties to promote the multi-brand expansion in the manufacturer X, and obtain a larger effect of the campaign.

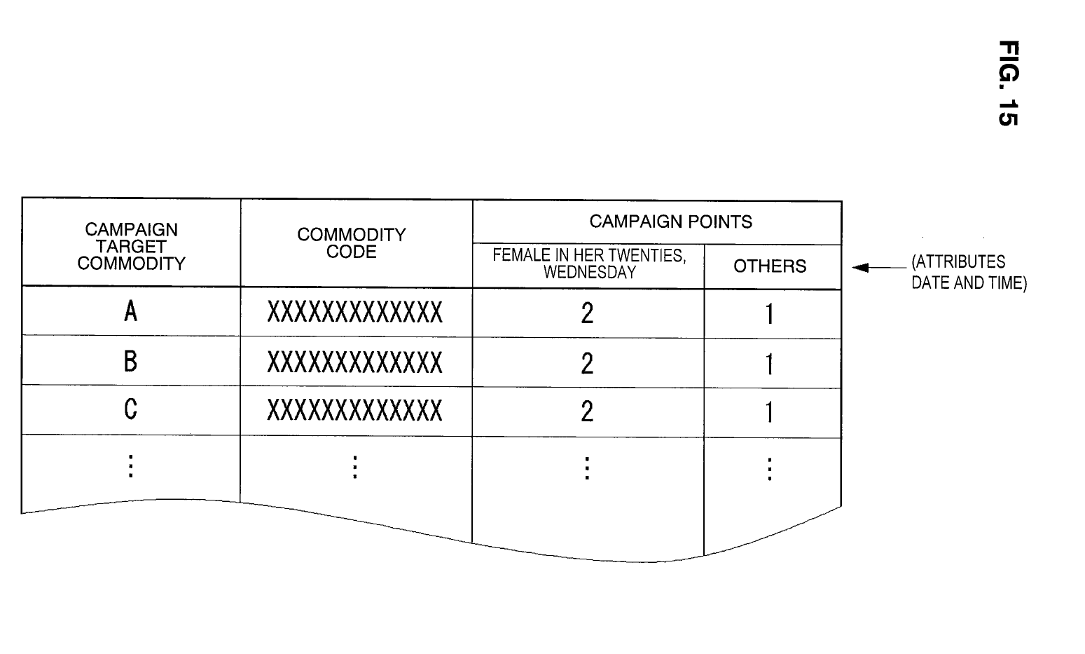

(5) FIG. 15 shows another example of the point rule. In FIG. 15, the value of the campaign points is set to be different depending on the date and time of purchase.

More particularly, in FIG. 15, the campaign points are different depending on the attributes and the date of purchase. When the attributes are female and twenties, and the date of purchase is Wednesday, the campaign points are 2 points (twice) (it should be noted that, since a day of the week corresponds one-on-one to the date, the day of the week is herein a kind of the date and time). If the attributes or the date of purchase is different, the campaign point is 1 point.

If the point rule of FIG. 15 is applied, when the point decision unit 73 decides the campaign points, the point decision unit 73 refers to the date and time of purchase data in the purchase history in the purchase history data storage unit 33, further refers to the sex data and the age bracket data in the target person data storage unit 37, and decides the campaign points based on the date and time of purchase data, the sex data and the age bracket data, according to the point rule. The campaign points corresponding to the date and time of purchase, the sex and the age bracket are obtained from a table of FIG. 15.

In this way, according to this embodiment, the campaign points can be changed depending on the date and time of purchase. The campaign points for the date and time when the sales are desired to be strategically promoted may be set to be larger than the campaign points for other dates and times. Thereby, it is possible to increase the effect of the campaign.

Moreover, in this embodiment, the campaign points are different depending on the attributes, in addition to the date and time of purchase. Thereby, the more points are accumulated if a person with certain attributes (for example, female and twenties) purchases the campaign target commodity on certain date and time (for example, Wednesday). For example, a campaign expansion such as “ladies day”, which has not been seen in conventional premium campaigns, also becomes possible.

In the above described example, specifically, the campaign points are different depending on the date of purchase. The campaign points may be different depending on a period of time of purchase. Moreover, the campaign points may be different depending on both the date of purchase and the time of purchase. All of these are included in “setting the campaign points which are different depending on the date and time of purchase” in the present invention.

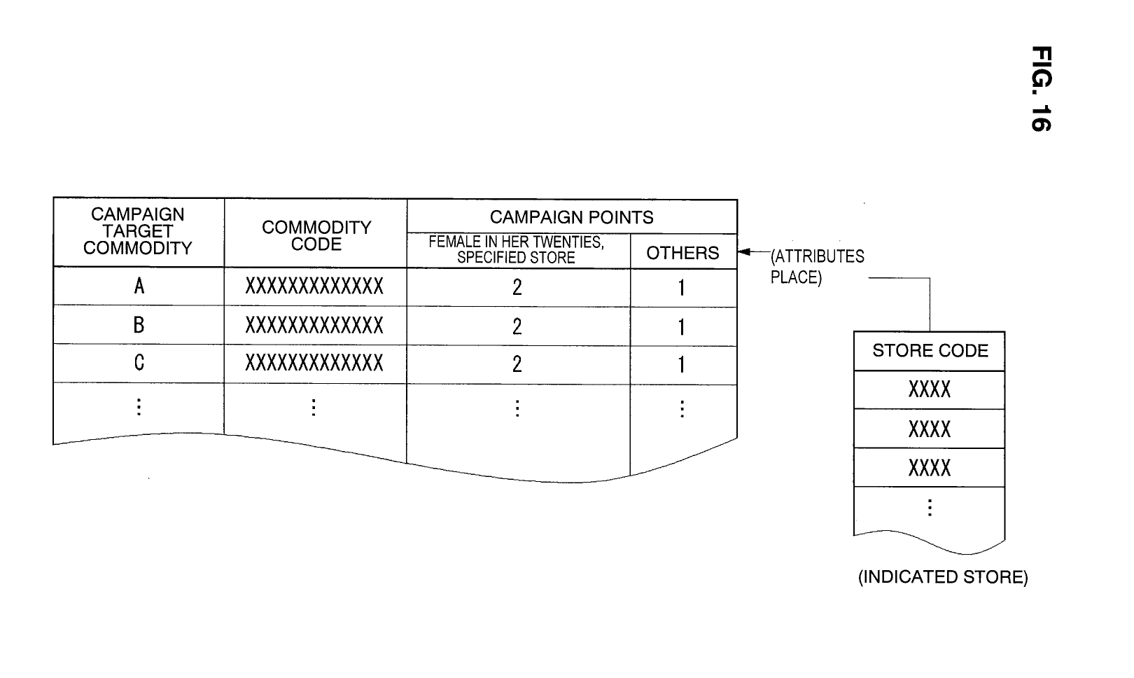

(6) FIG. 16 shows another example of the point rule. In the point rule of FIG. 16, the value of the campaign points is set to be different depending on the place of purchase. More particularly, in FIG. 16, the campaign points are different depending on the attributes and the place of purchase. The place of purchase is identified by the store of purchase. The store of purchase data is a code of the store of purchase, and is also included in the purchase history data.

If the point rule of FIG. 16 is applied, when the point decision unit 73 decides the campaign points, the point decision unit 73 refers to the sex data and the age bracket data in the target person data storage unit 37, also refers to the store of purchase data in the purchase history in the purchase history data storage unit 33, and decides the campaign points based on the place of purchase and the attributes (the sex and the age bracket), according to the point rule.

In this way, according to this embodiment, the campaign points can be changed depending on the place of purchase. It is possible to strategically set the campaign points to be different and intend to increase the effect of the campaign.

In this embodiment, furthermore, the campaign points are different depending on the attributes, in addition to the place of purchase. Thereby, more points are accumulated if the person with certain attributes purchases the campaign target commodity at a certain place, and also here, the campaign expansion which has not been seen in the conventional premium campaigns becomes possible.

In FIG. 16, the place of purchase is identified by specifying the store of purchase. The store of purchase to be specified may be a store in a geographically specific district. The store of purchase may be a store of a specific distribution institution (for example, a store chain).

The data on the place of purchase may be data on other than the store of purchase. The place of purchase may be directly represented by a district of purchase code or a distribution institution code. In this case, the purchase history data also preferably includes the district of purchase code or the distribution institution code.

Hereinabove, various examples of the point rule have been described. Furthermore, other point rules are also applicable. For example, the above described multiple point rules may be appropriately combined. More particularly, in the above description, multiple kinds of elements such as the attributes, the commodity or the combination of the commodities, the date and time, and the place have been presented. These elements may be appropriately combined.

Conversely, some of the above described composite point rules may be employed. For example, the elements of the attributes may be deleted from the point rule of FIG. 15 and the campaign points may be decided depending on the date and time of purchase. Similarly, the elements of the attributes may be deleted from the point rule of FIG. 16 and the campaign points corresponding to the place of purchase may be set.

As a further variation of this embodiment, the campaign information processing system 1 may be provided with a commodity information database. The commodity information database may include various commodity classification codes, in addition to the commodity code. The commodity information database may include commodity specs such as a commodity price. Commodity information may be used for use in the marketing and the like.

Moreover, in the above description, the commodity code is, for example, the JAN code. The commodity code may be other codes if the codes can identify the commodity. For example, a code for identifying the manufacturer may be handled as the commodity code. In this case, the campaign target commodity code storage unit stores the code for identifying the manufacturer as the campaign target commodity code. Then, the commodity of the appropriate manufacturer becomes the campaign target commodity. In other configurations, the code of the manufacturer may be handled as the code for identifying the commodity. In the point rule and the like, the code of the manufacturer may be handled as the commodity code.

Moreover, in this embodiment, the drawing is performed after the application qualification is generated. However, the drawing may not be performed. In this case, the premium is granted with respect to all persons (all electronic money numbers) for which the application qualification is generated (without omission).

In this embodiment, the points are accumulated, and when the points reach a predetermined value, the application qualification is generated. However, within the range of the present invention, a system which does not use the points may also be included. In this case, each time the commodity is purchased, one application qualification may be generated.

Moreover, in this embodiment, when the application qualification has been generated, the application qualification notification message has been transmitted by the application qualification notification unit 43, and subsequently the drawing is performed, and the drawing result message is transmitted by the drawing result notification unit 55. However, the present invention is not limited thereto. As a variation, the application qualification notification message may not be transmitted. In FIG. 3, the application qualification notification unit 43 and the application qualification notification message storage unit 45 may be deleted. Without transmitting the application qualification notification message, the drawing may be automatically implemented and a drawing result notification message may be transmitted. The drawing result notification message may be transmitted only to the winner. Moreover, in this case, the drawing may be performed at the same time as the generation of the application qualification, and the drawing result may be immediately notified.

Hereinabove, the preferred embodiment of the present invention which is conceivable at the present moment has been described. However, it is intended to be understood that various variations are possible with respect to this embodiment, and it is intended that the accompanying claims include all such variations within the true spirit and the range of the present invention.

### INDUSTRIAL APPLICABILITY

As described above, the present invention is useful as an information processing system which performs the data processing for generating the application qualification for the premium campaign to support campaign implementation.

1. A campaign information processing system which performs data processing for generating an application qualification for a premium campaign on a computer, comprising:
a purchase history data storage unit which stores purchase history data including electronic payment ID data specific to each electronic payment medium and a purchased commodity code which is a commodity code of a purchased commodity, as data on history of purchasing the commodity by using the electronic payment medium;
a campaign target commodity code storage unit which stores a campaign target commodity code which is the commodity code of a campaign target commodity of a target campaign; and
a campaign application qualification generation and registration unit which compares said purchased commodity code included in said purchase history data in said purchase history data storage unit, with said campaign target commodity code in said campaign target commodity code storage unit, generates a campaign application qualification corresponding to said electronic payment ID data included in the purchase history data including said purchased commodity code which matches said campaign target commodity code, and registers said campaign application qualification data in association with said electronic payment ID data.

2. The campaign information processing system according to claim 1, comprising:
a target person data storage unit which stores at least contact data for communication of each campaign target person and said electronic payment ID data of said electronic payment medium owned by each campaign target person, as data on the campaign target person of said target campaign;
an application qualification notification message storage unit which stores an application qualification notification message for notifying said generation of said campaign application qualification; and
an application qualification notification unit which, based on said electronic payment ID data and said contact data in said target person data storage unit, transmits said application qualification notification message to said campaign target person by using said contact data corresponding to said electronic payment ID data for which said campaign application qualification data is generated in the campaign application qualification generation and registration unit.

3. The campaign information processing system according to claim 1, wherein:
the campaign information processing system comprises a target person data storage unit which stores at least contact data for communication of each campaign target person and said electronic payment ID data of said electronic payment medium owned by each campaign target person, as data on the campaign target person of said target campaign; and
said campaign application qualification generation and registration unit comprises:
a point rule storage unit which stores a point rule which prescribes campaign points to be granted depending on the purchase of said campaign target commodity;
a point decision unit which decides the campaign points to be granted with respect to said electronic payment ID data included in the purchase history data including said purchased commodity code which matches said campaign target commodity code, according to said point rule in said point rule storage unit;
a point registration unit which registers the campaign points decided by said point decision unit, in said target person data storage unit, in association with said electronic payment ID data;
a qualification generation determination unit which determines that the campaign application qualification is generated, when the campaign points stored in said target person data storage unit reach predetermined application qualification generation points; and
a qualification registration unit which, in response to a result of the determination in said qualification generation determination unit, registers said campaign application qualification data in said target person data storage unit, in association with said electronic payment ID data for which said campaign application qualification is generated.

4. The campaign information processing system according to claim 1, comprising:
a target person data storage unit which stores at least contact data for communication of each campaign target person and said electronic payment ID data of said electronic payment medium owned by each campaign target person, as data on the campaign target person of said target campaign; and
a campaign subscription registration processing unit which accepts an input of said electronic payment ID data retained by a subscriber for participation in said target campaign, regards said subscriber for the participation as said campaign target person, and registers said electronic payment ID data in said target person data storage unit.

5. The campaign information processing system according to claim 3, wherein said point rule storage unit stores, as said point rule, said campaign target commodity and a value of the campaign points to be granted by the purchase of said campaign target commodity.

6. The campaign information processing system according to claim 5, wherein said point rule prescribes the value of the campaign points to be granted depending on a quantity of purchase or a purchased amount of money of said campaign target commodity.

7. The campaign information processing system according to claim 5 or 6, wherein:
said target person data storage unit stores attribute data of said campaign target person in association with said electronic payment ID data;
in the point rule in said point rule storage unit, the value of the campaign points is set to be different depending on attributes of said campaign target person; and
said point decision unit reads said attribute data in said target person data storage unit, and decides said campaign points according to said point rule, based on said attribute data.

8. The campaign information processing system according to claim 7, wherein:
said target person data storage unit stores sex data as said attribute data; and
in said point rule, the value of the campaign points is set to be different depending on sex of said campaign target person.

9. The campaign information processing system according to claim 7 or 8, wherein:
said target person data storage unit stores age data as said attribute data; and
in said point rule, the value of the campaign points is set to be different depending on age of said campaign target person.

10. The campaign information processing system according to any of claims 5 to 9, wherein:
said point rule storage unit stores combination campaign points corresponding to a combination of predetermined multiple campaign target commodities, as said point rule; and
said point decision unit obtains a value of said combination campaign points according to said point rule when said predetermined multiple campaign target commodities prescribed in said point rule are purchased in combination.

11. The campaign information processing system according to any of claims 5 to 10, wherein:
said purchase history data storage unit further stores date and time of purchase data as said purchase history data;
in the point rule in said point rule storage unit, the value of the campaign points is set to be different depending on date and time of purchase of said campaign target commodity; and
said point decision unit reads said date and time of purchase data in said purchase history data in said purchase history data storage unit, and obtains said campaign points according to said point rule, based on said date and time of purchase data.

12. The campaign information processing system according to any of claims 5 to 11, wherein:
said purchase history data storage unit further stores place of purchase data as said purchase history data;
in the point rule in said point rule storage unit, the value of the campaign points is set to be different depending on a place of purchase of said campaign target commodity; and
said point decision unit reads said place of purchase data in said purchase history data in said purchase history data storage unit, and obtains said campaign points according to said point rule, based on said place of purchase data.

13. A campaign information processing method which performs data processing for generating an application qualification for a premium campaign on a computer, comprising:
storing purchase history data including electronic payment ID data specific to each electronic payment medium and a purchased commodity code which is a commodity code of a purchased commodity, as data on history of purchasing the commodity by using the electronic payment medium, in a purchase history data storage unit configured with storage means of said computer;
storing a campaign target commodity code which is the commodity code of a campaign target commodity of a target campaign, in a campaign target commodity code storage unit configured with the storage means of said computer; and
comparing said purchased commodity code included in said purchase history data in said purchase history data storage unit, with said campaign target commodity code in said campaign target commodity code storage unit, generating a campaign application qualification corresponding to said electronic payment ID data included in the purchase history data including said purchased commodity code which matches said campaign target commodity code, and registering said campaign application qualification data in association with said electronic payment ID data.

14. A campaign information processing program which causes a computer to execute data processing for generating an application qualification for a premium campaign, wherein the campaign information processing program causes said computer to execute a process of:
causing a purchase history data storage unit configured with storage means of said computer to store purchase history data including electronic payment ID data specific to each electronic payment medium and a purchased commodity code which is a commodity code of a purchased commodity, as data on history of purchasing the commodity by using the electronic payment medium;
causing a campaign target commodity code storage unit configured with the storage means of said computer to store a campaign target commodity code which is the commodity code of a campaign target commodity of a target campaign; and
comparing said purchased commodity code included in said purchase history data in said purchase history data storage unit, with said campaign target commodity code in said campaign target commodity code storage unit, generating a campaign application qualification corresponding to said electronic payment ID data included in the purchase history data including said purchased commodity code which matches said campaign target commodity code, and registering said campaign application qualification data in association with said electronic payment ID data.
